(19) United States
(12) Patent Application Publication
(10) Pub. No.: US 2003/0026544 A1
(43) Pub. Date: Feb. 6, 2003

(54) Optical component having a light distribution component with a functional region

(76) Inventor: Wenhua Lin, Pasadena, CA (US)

Correspondence Address: Travis Dodd, 2490 Heyneman Hollow, Fallbrook, CA, 92028, US

(21) Appl. No.: 09/924,403

(22) Filed: Aug. 6, 2001

(51) Int. Cl. G02B 6/26

(52) U.S. Cl. 385/39; 385/15; 385/24; 385/37; 385/46

(57) ABSTRACT

An optical component is described. The optical component includes a light distribution component having a light signal carrying region for carrying a light signal through the light distribution component. The optical component also includes a functional region positioned in the light distribution component such that the light signal carrying region extends through at least a portion of the functional region. The index of refraction of the light signal carrying region inside of the functional region is different from the index of refraction of the light signal carrying region outside of the functional region. Additionally, the functional region is shaped such that the dispersion profile of the light signal changes in response to traveling through the functional region. In some instances, the light distribution component has the geometry of a star coupler or a Rowland circle.

### BACKGROUND

1. Field of the Invention

The invention relates to one or more optical networking components. In particular, the invention relates to optical components having one or more waveguides defined in a light transmitting medium positioned on a base.

2. Background of the Invention

Optical networks include optical fibers that carry light signals to a variety of optical components. Each light signal typically includes a distribution of wavelengths. Different wavelengths tend to travel along the optical fibers at different speeds. As a result, the light signal tends to disperse as the light signal travels along the optical fiber. Significant levels of dispersion can affect the performance of the optical network.

For the above reasons, there is a need for optical components that compensate for and/or correct the effects of dispersion.

### SUMMARY OF THE INVENTION

The invention relates to an optical component. The optical component includes a light distribution component having a light signal carrying region for carrying a light signal through the light distribution component. The optical component also includes a functional region positioned in the light distribution component such that the light signal carrying region extends through at least a portion of the functional region. The index of refraction of the light signal carrying region inside of the functional region is different from the index of refraction of the light signal carrying region outside of the functional region. Additionally, the functional region is shaped such that the dispersion profile of the light signal changes in response to traveling through the functional region.

The functional region can be configured so as to broaden or narrow the dispersion profile of the light signal as the light signal travels through the functional region. Additionally or alternatively, the functional region can be configured so as to increase or decrease the dispersion slope of the light signal as the light signal travels through the functional region. Further, the functional region can be configured so as to compensate for higher order dispersion effects.

In some instances, the optical component includes an array waveguide grating having a plurality of array waveguides in optical communication with the light distribution component such that the light signal carrying region extends from the light distribution component into the array waveguides. The light distribution component serves as an input light distribution component configured to distribute the light signal across the array waveguides of the array waveguide grating such that each array waveguide receives a portion of the light signal. The optical component can also include an output light distribution component configured to receive the portions of the light signal from the array waveguides and to combine the portions of the light signal into an output light signal directed toward an output side of the second light distribution component.

In some instances, the optical component can include an array waveguide grating having a plurality of array waveguides in optical communication with the light distribution component such that the light signal carrying region extends from the light distribution component into the array waveguides. The light distribution component serves as an output light distribution component positioned to receive a portion of the light signal from each array waveguide and to combine the portions of the light signal into an output light signal directed toward an output side of the light distribution component. The optical component can also include an input light distribution component configured to distribute the light signal to the array waveguides such that each array waveguide receives a portion of the light signal.

The optical component can include an array waveguide grating having a plurality of array waveguides in optical communication with the light distribution component such that the light signal carrying region extends from the light distribution component into the array waveguides. Each array waveguide is configured to carry a portion of the light signal. At least a portion of the array waveguides are associated with a path through the functional region in that the portion of the light signal traveling through an array waveguide also travels through the functional region along the associated path. Each path through the functional region can be associated with a path index j.

The functional region can be designed such that the length of each path includes one or more exponential functions having a base that is a function of the array waveguide index j. In some instances, the exponential function includes β(j+C)^{α} where C, α and β each have a constant value for each array waveguide. In some instances, α is about 2 and in other instances α is greater than 2. The value of β can be positive or negative.

The functional region can be designed such that the length of each path includes a linear function of the path index, j. In some instances, the linear function includes jΔP where ΔP is a constant for each path.

The invention also relates to a method of operating an optical component. The method includes receiving a light signal in a light distribution component having a light signal carrying region with an index of refraction. The method also includes directing the light signal through a functional region. The functional region is positioned in the light distribution component such that the light signal carrying region extends through the functional region. The index of refraction of the light signal carrying region inside of the functional region is different from the index of refraction of the light signal carrying region outside of the functional region. The functional region can be shaped so as to change the dispersion profile of a light signal traveling through the functional region.

The invention also relates to a method of fabricating an optical component. The optical component includes forming a light distribution component in a light transmitting medium positioned on a base. The light distribution component is formed so as to have a light signal carrying region defined in the light transmitting medium. The method also includes removing a portion of the light transmitting medium so as to define a functional region in the light distribution component.

The light transmitting medium can be removed such that the light signal carrying region is thicker inside of the functional region than outside of the functional region. In some instances, the light transmitting medium is removed such that the light signal carrying region is thinner inside of the functional region than outside of the functional region.

The method can also include forming a reflective layer over the functional region with air remaining in the functional region.

The method can alternatively include forming a second light transmitting medium in the functional region after removing the light transmitting medium from the functional region, the second light transmitting medium having a different index of refraction than the light transmitting medium.

### BRIEF DESCRIPTION OF THE FIGURES

FIG. 1A illustrates an embodiment of an optical component. The optical component includes an input light distribution component with a functional region. The functional region is configured to provide the optical component with functionality such as demultiplexing functionality and/or dispersion compensating functionality.

FIG. 1B illustrates the optical component having an output light distribution component with a functional region.

FIG. 1C illustrates the optical component having an input light distribution component with a functional region. The input light distribution component includes ports located in an input side and an output side. The functional region is spaced apart from the ports.

FIG. 1D illustrates the optical component including more than one functional region.

FIG. 2A illustrates operation of an input light distribution component.

FIG. 2B illustrates operation of an output light distribution component.

FIG. 3A shows the dispersion profile of a light signal before the light signal enters the functional region.

FIG. 3B shows the dispersion profile of the light signal after the light signal exits the functional region. The functional region is constructed such that the dispersion profile is narrower after exiting the functional region than before entering the functional region.

FIG. 3C shows the dispersion profile of a light signal before the light signal enters the functional region.

FIG. 3D shows the dispersion profile of the light signal after the light signal exits the functional region. The functional region is constructed such that the dispersion profile is broader after exiting the functional region than before entering the functional region.

FIG. 3E shows the dispersion profile of a light signal before the light signal enters the functional region.

FIG. 3F shows the dispersion profile of the light signal after the light signal exits the functional region. The functional region is constructed such that the dispersion profile of FIG. 3F has positive dispersion slope relative to the dispersion profile shown in FIG. 3E.

FIG. 3G shows the dispersion profile of a light signal before the light signal enters the functional region.

FIG. 3H shows the dispersion profile of the light signal after the light signal exits the functional region. The functional region is constructed such that the dispersion profile of FIG. 3H has negative dispersion slope relative to the dispersion profile shown in FIG. 3G.

FIG. 4A illustrates an optical component having a single light distribution component.

FIG. 4B illustrates another embodiment of an optical component having a single light distribution component.

FIG. 5A illustrates a suitable construction for an optical component having light distribution component with a functional region.

FIG. 5B is a topview of an optical component having a light distribution component with a functional region.

FIG. 5C is a cross section of the optical component in FIG. 5B taken at any of the lines labeled A.

FIG. 5D is a cross section of a light distribution component having a light signal carrying region having a different thickness in a functional region than outside of the functional region.

FIG. 5E is a cross section of a light distribution component having a different light transmitting medium in a functional region than outside of the functional region.

FIG. 5F is a cross section of a light distribution component having a gas in the functional region.

FIG. 5G and FIG. 5H are cross sections of a light distribution component having a functional region with a side that is angled at less than ninety degrees relative to a base.

FIG. 5I illustrates an optical component having a cladding layer positioned over a light transmitting medium.

FIG. 5J illustrates a suitable construction of a reflector for use with an optical component.

FIG. 6A illustrates an optical component having a base with a light barrier positioned over a substrate.

FIG. 6B illustrates an optical component having a base having a light barrier with a surface positioned between sides. A waveguide is formed over the surface and a light transmitting medium is positioned adjacent to the sides.

FIG. 7A through FIG. 7F illustrate a method for forming a component having a light distribution component with a functional region.

### DETAILED DESCRIPTION OF THE PREFERRED EMBODIMENT

The invention relates to an optical component having a selectable functionality. For instance, the optical component can be constructed to have demultiplexing functionality and/or dispersion compensation functionality. The optical component includes a light distribution component having a light signal carrying region for carrying light signals to be processed by the optical component. The light distribution component includes a functional region. The light signal carrying region extends through the functional region such that at least a portion of a light signal traveling through the light distribution component passes through the functional region.

The functional region has a shape that provides the optical component with the desired functionality. For instance, the functional region can be shaped so as to change the dispersion profile of a light signal passing through the functional region. The dispersion profile is the intensity versus time profile of the light signal. The shape of the functional region can be selected so as to narrow (or broaden) the dispersion profile of a light signal passing through the functional region. Alternatively or additionally, the shape of the functional region can be selected to increase (or decrease) the dispersion slope of a light signal passing through the functional region. Further, the shape of the functional region can be selected so as to change the degree of change in the dispersion profile. As a result, the optical component can be designed so as to output a light signal having a selected dispersion profile.

Because the dispersion profile of the light signals can be selected, the optical component can be used to correct for the effects of dispersion on optical networks. For instance, an optical component configured to convert an input light signal to an output light signal having a narrower intensity versus time profile can be positioned before optical components that require narrow intensity versus time profiles. Alternatively, a dispersion compensator configured to convert an input light signal to an output light signal having a narrower intensity versus time profile can be positioned before long optical fiber runs to compensate for the dispersion that occurs during the optical fiber run.

In some instances, the functional region is shaped so as to provide a demultiplexing function. The demultiplexing function causes the optical component to direct output light signals having different wavelengths to different output waveguides. Different channels of an optical network are typically carried on light signals having different wavelengths. As a result, an optical component configured to provide demultiplexing function can cause different channels to appear on different output waveguides. In some instances, the optical component is designed to have demultiplexing functionality in addition to dispersion compensation functionality. As a result, the optical component can be configured to output different channels on different output waveguides and each of the channels can have the desired dispersion profile.

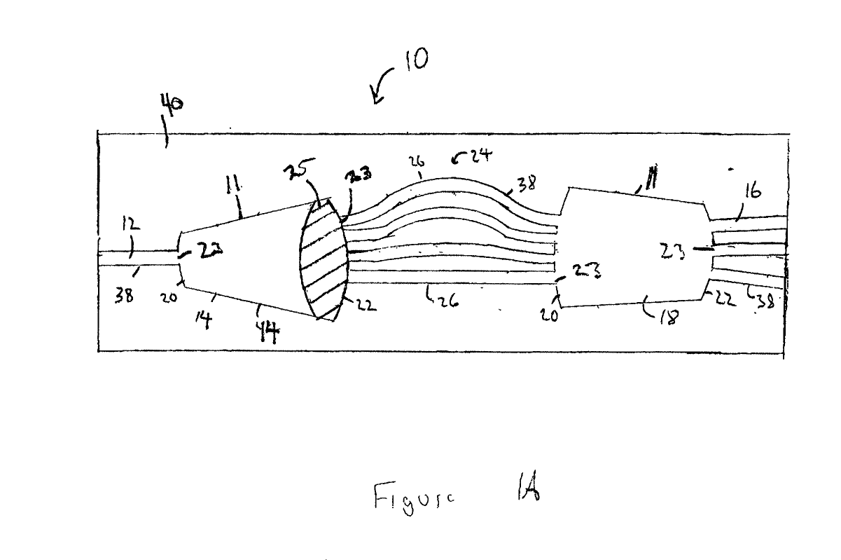

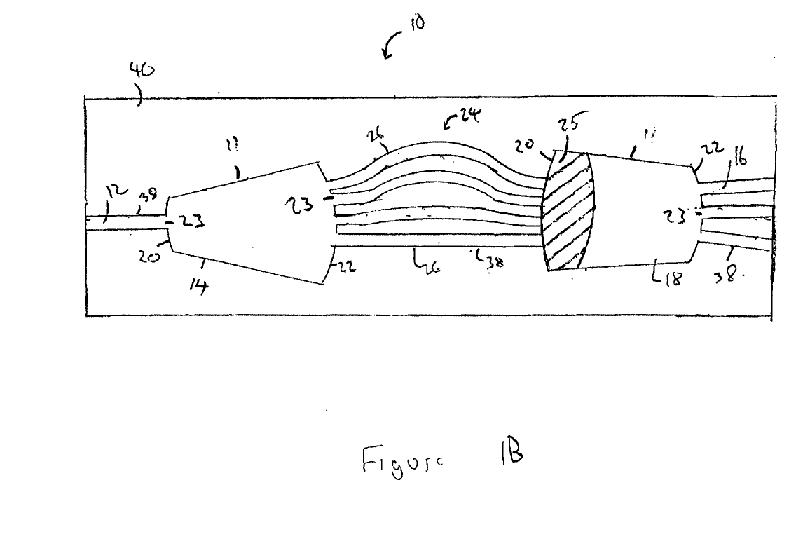

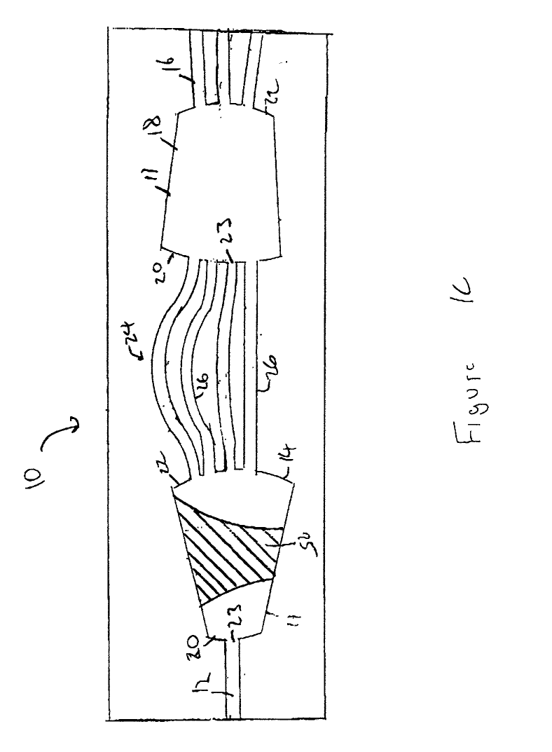

FIG. 1A illustrates an embodiment of an optical component 10 according to the present invention. The optical component 10 includes a plurality of light distribution components 11. For instance, the optical component 10 includes at least one input waveguide 12 in optical communication with an input light distribution component 14 and a plurality of output waveguides 16 in optical communication with an output light distribution component 18. The light distribution components 11 each have an input side 20 and an output side 22. Further, the input side 20 and the output side 22 each have one or more ports 23 through which a light signal or portions of a light signal enter or exit the light distribution component 11. The light distribution components 11 are configured to distribute a light signal from one or more ports 23 on the input side 20 to one or more ports 23 on the output side 22. For instance, a light distribution component can be configured to distribute a light signal from one port 23 on the input side 20 to a plurality of ports 23 on the output side 22 or from a plurality of ports 23 on the input side 20 to a single port 23 on the output side 22. Suitable light distribution components 11 include, but are not limited to, star couplers, Rowland circles, multi-mode interference devices, mode expanders and slab waveguides.

An array waveguide grating 24 connects the input light distribution component 14 and the output light distribution component 18. The array waveguide grating 24 includes a plurality of array waveguides 26 that each has a length. Because the array waveguides 26 are often curved, the length is not consistent across the width of the array waveguide 26. As a result, the length of an array waveguide 26 can refer to the length of an array waveguide 26 averaged across the width of the array waveguide 26. Further, the length of an array waveguide 26 can refer to the effective length of the array waveguide 26. Although four array waveguides 26 are illustrated, array waveguide gratings 24 typically include many more than four array waveguides 26 and fewer are possible. Increasing the number of array waveguides 26 can increase the degree of resolution provided by the array waveguide grating 24.

The optical component 10 includes a light signal carrying region 46 (not illustrated) where light signals to be processed by optical component 10 are carried. The light signal carrying region 46 extends through the input waveguide 12, the input light distribution component 14, the array waveguides 26, the output light distribution component 18 and the output waveguides 16.

During operation of the optical component 10, an input light signal traveling on the input waveguide 12 enters the input light distribution component 14 through the port 23 in the input side 20 of the input light distribution component 14. The input light distribution component 14 distributes the light signal across the output side 22 of the input light distribution component 14. A portion of the light signal enters each array waveguides 26 through a port 23 in the output side 22 of the input light distribution component 14. Accordingly, each array waveguide 26 receives a portion of the input light signal. Each array waveguide 26 carries the received light signal portion to the output light distribution component 18.

The light signal portions entering the output light distribution component 18 from each of the array waveguides 26 combine to form an output light signal. The output light distribution component 18 is constructed to converge the output light signal at a location on the output side 22 of the output light distribution component 18. An output waveguide 16 is positioned at the location on the output side 22 where the light signal is converged receives the output light signal.

Although FIG. 1A illustrates an optical component 10 having a single input waveguide 12, the optical component 10 can have a plurality of input waveguides 12. Further, the optical component 10 can have a single output waveguide 16. For instance, when the optical component 10 is designed without demultiplexing functionality, the optical component 10 can have a single output waveguide 16 that receives all the output light signals.

The input light distribution component 14 includes a functional region 25. The index of refraction in the light signal carrying region 46 in the functional region 25 is different than the index of refraction of the light signal carrying region 46 outside of the functional region 25. As a result, the light signal travels through the functional region 25 at a different speed than through the regions outside the functional region 25.

The functional region 25 has a shape selected to provide the optical component 10 with functionality. For instance, the functional region 25 can have a shape selected to provide the optical component 10 with demultiplexing functionality and/or a dispersion compensation functionality. Demultiplexing functionality causes light signals having different wavelengths to be directed to different regions on the output side 22 of the output light distribution component 18. Different output waveguides 16 can be positioned at each region where a light signal is directed. Accordingly, different output waveguides 16 can carry light signals having different wavelengths. Dispersion compensation functionality causes the output light signal to have a different dispersion profile than the input light signal. The dispersion profile of a light signal is the intensity versus time profile of the light signal.

Although FIG. 1A illustrates the functional region 25 as being positioned in the input light distribution component 14, the functional region 25 can be positioned in the output light distribution component 18 as illustrated in FIG. 1B. Additionally, the functional region 25 need not be positioned adjacent to the output side of the light distribution component as illustrated in FIG. 1A or adjacent to the input side of the light distribution component FIG. 1B. For instance, the functional region 25 can be spaced apart from the input side and the output side as shown in FIG. 1C. Further, the optical component 10 can include more than one functional region. For instance, the optical component 10 can include a first functional region located in the input light distribution component and a second functional region located in the output light distribution component as shown in FIG. 1D. Additionally, the functional region 25 can be positioned adjacent to the input waveguide(s) 12 or the output waveguide(s) 16. Further, a functional region 25 can span different regions of the optical component 10. For instance, a functional region 25 can be positioned in the input light distribution component 14 and extend into the array waveguide grating 24. Additionally, a functional region 25 can be positioned in the input light distribution component 14, extend across the array waveguides 26 and be positioned in the output light distribution component 18. Further, an optical component 10 can include a plurality of functional regions 25.

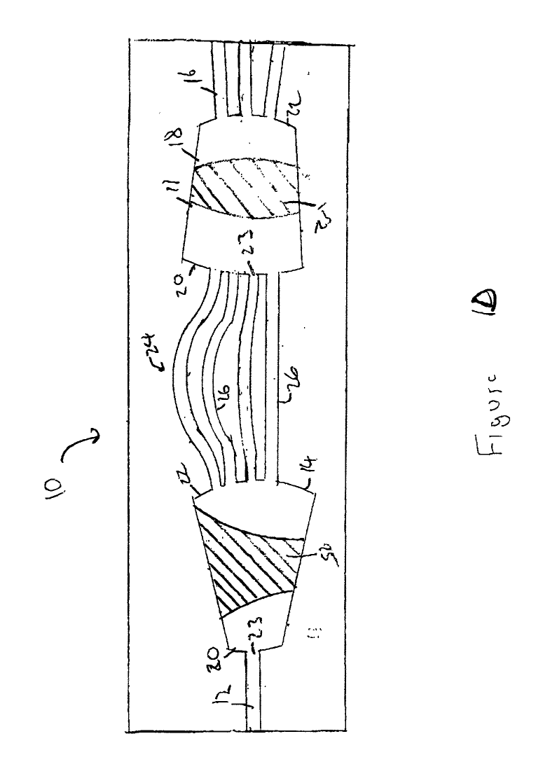

FIG. 2A illustrates operation of an input light distribution component 14 having a functional region 25. A light signal is shown entering the input light distribution component 14 from the input waveguide 12. Each line labeled A illustrates a portion of the light signal traveling from the input waveguide 12 to an array waveguide 26. Each portion of the light signal travels through the functional region 25 before entering an array waveguide 26. As a result, each array waveguide 26 is associated with a path through the functional region 25 in that the portion of the light signal that travels through an array waveguide 26 also travels along the associated path through the functional region 25. The path that the light signal travels through the functional region 25 is illustrated as a dashed line.

FIG. 2B illustrates operation of an output light distribution component 18 having a functional region 25. The output light distribution component 18 is configured to receive portions of a light signal from the array waveguides 26. For instance, portions of a light signal are shown entering the output light distribution component 18 from the array waveguide grating 24. Each of the lines labeled A illustrates a portion of the light signal traveling from an array waveguide 26 to the output waveguide 16. Each portion of the light signal travels from an array waveguide 26 through the functional region 25 before entering the output waveguide 16. As a result, each array waveguide 26 is associated with a path through the functional region 25 in that the portion of the light signal that travels through an array waveguide 26 also travels along the associated path through the functional region 25. The path that the light signal travels through the functional region 25 is illustrated as a dashed line.

As illustrated in FIG. 2A and FIG. 2B, each path through the functional region can be associated with a path index labeled j. The value of the path index is different for each path and the difference in the value of the path index for adjacent paths is 1. Additionally, the length of path j can be denoted by a pathlength labeled, Pⱼ.

As noted above, the index of refraction of the light distribution component in the functional region is different from the index of refraction outside of the functional region. Because the index of refraction is different inside and outside of the functional region, the speed of a light signal is different inside of the functional region and outside of the functional region. Accordingly, the change in the index of refraction changes the effective length of a path through the functional region from what the effective length would be without the change of index of refraction. For instance, the change in the effective length of a path due to the change in index of refraction is (n_{f}−nₛ)*Pⱼ where n_{f} is the index of refraction of the light signal carrying region in the functional region and nₛ is the index of light signal carrying region outside of the functional region. Because the portion of the light signal that travels along a path travels through the associated array waveguide, the change in the effective length of each path can be viewed as a change to the effective length of an array waveguide.

The change in effective lengths caused by the change in index of refraction in the functional region is the source of the functionality provide by the optical component 10. Accordingly, pathlengths, Pⱼ, are selected so as to provide the optical component 10 with the desired functionality. For instance, the functional region 25 can be designed to have pathlengths that provide the optical component 10 with a demultiplexing function and/or with a dispersion compensation function. As a result, the shape of the functional region 25 is determined by the functionality desired from the optical component 10. Because the functional region 25 in each of the illustrated optical components 10 can provide the optical component 10 with different functions, the illustrated shape of the illustrated functional regions 25 are only for the purpose of illustrating the functional region 25 and the actual shape of the functional region 25 may be different.

Each pathlength, Pⱼ, through the functional region 25 can have a constant component, Po, and one or more variable components, P(j). The constant component, Po, can be a length that is the same for each path and can be equal to zero. The variable component, P(j), is a function of the path index, j. The length of each path is Pⱼ=Po+P(j).

The variable component, P(j), can include a dispersion changing function, P_{DC}(j), that causes the dispersion profile of the light signal to change as the light signal travels through the functional region. A suitable dispersion changing function, P_{DC}(j), includes, but is not limited to, an exponential function with a base that is a function of the array waveguide 26 index j. The exponential function causes the profile of the light signal to change in response to traveling across the functional region. Equation 1 is an example of a suitable exponential function where f(j) indicates some function of the array waveguide 26 index j. Additionally, and β and α are constants for each of the array waveguides 26 and are both non zero.

P(j)=P_{DC}(j)=β(f(j))^{α} (1)

A suitable f(j) includes, but is not limited to, j+C as shown in Equation 2. The C is a constant value for each array waveguide 26 and can be zero, have a negative value or a positive value.

P(j)=P_{DC}(j)=β(j+C)^{α} (2)

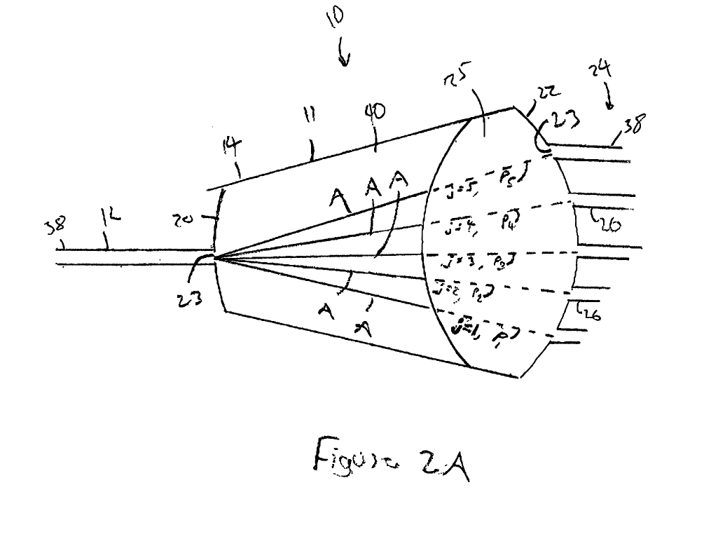

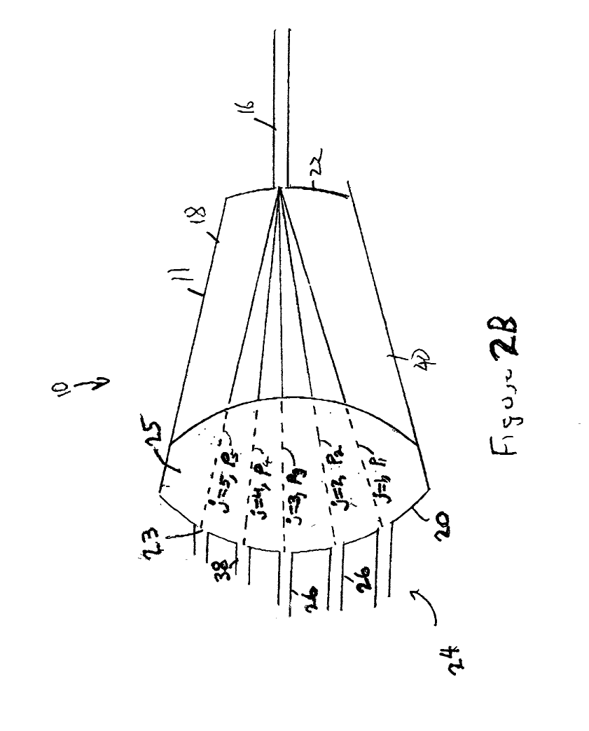

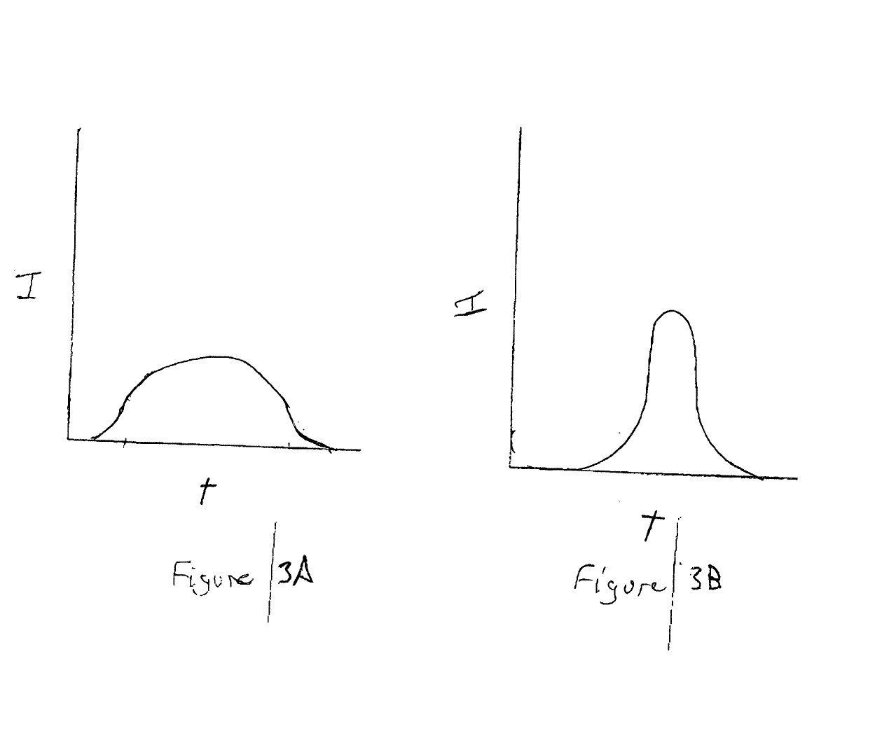

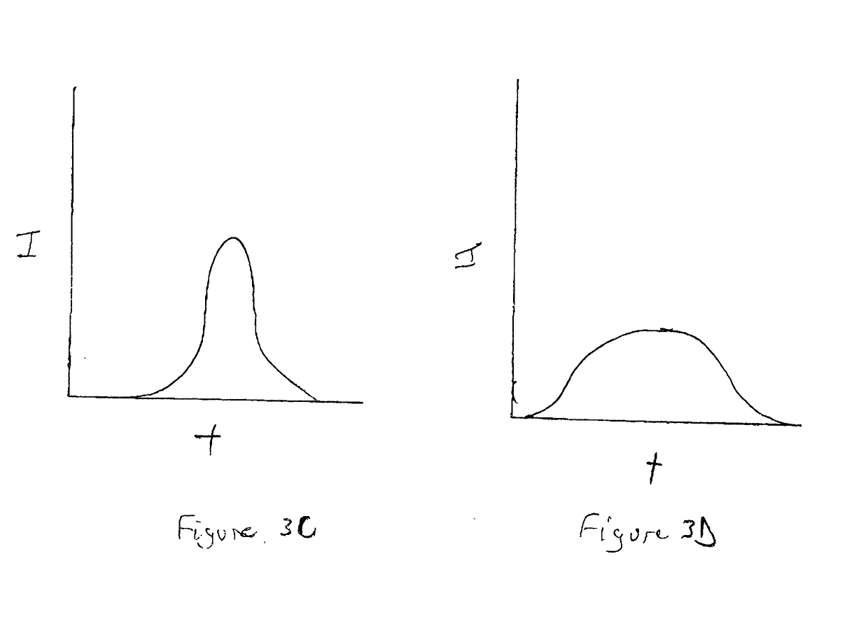

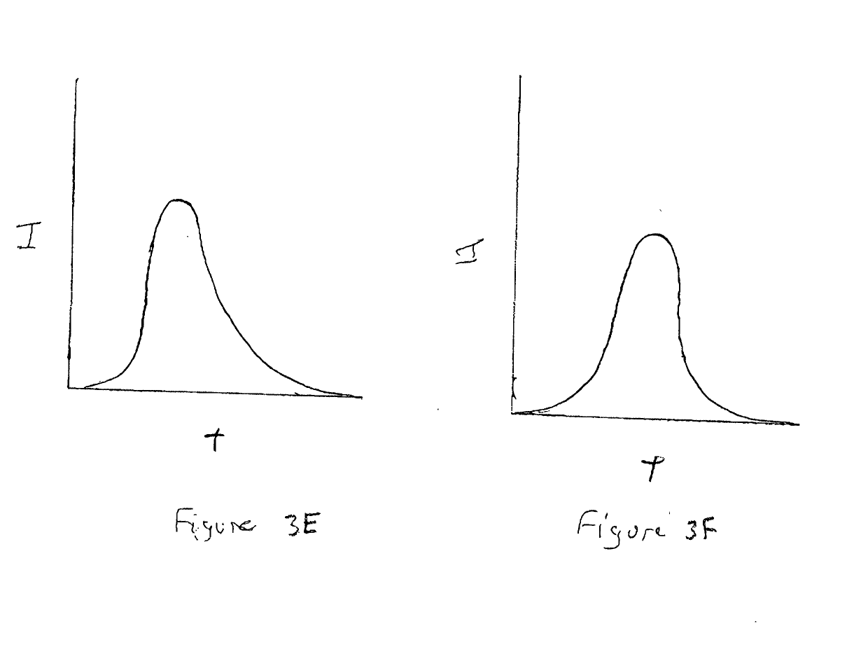

When α is equal to 2, β is negative and (n_{f}−nₛ)>0 or when α is equal to 2, β is positive and (n_{f}−nₛ)<0, the dispersion profile narrows as shown in FIG. 3A and FIG. 3B. FIG. 3A shows the dispersion profile of the light signal before entering the functional region 25. FIG. 3B shows the dispersion profile of the light signal after exiting the functional region 25. The dispersion profile of light signal narrows in response to the light signal passing through the functional region 25. Accordingly, the functional region 25 causes the light signal to undergo negative dispersion. This negative dispersion change can be generated from the phase 2*π*(n_{f}−nₛ)*P_{DC}/λ. The degree of dispersion change increases as the magnitude of β increases. Accordingly, the magnitude of β can be increased when a narrower dispersion profile is desired.

When α is equal to 2, β is positive and (n_{f}−nₛ)>0 or when α is equal to 2, β is negative and (n_{f}−nₛ)<0, the dispersion profile broadens as shown in FIG. 3C and FIG. 3D. FIG. 3C shows the dispersion profile of the light signal as the light signal before entering the functional region 25 and FIG. 3D shows the dispersion profile of the light signal after the light signal exits the functional region 25. The dispersion profile of the light signal broadens in responses to passing through the functional region 25. Accordingly, the functional region 25 causes the input light signal to undergo positive dispersion. This positive dispersion can be generated from the phase 2*π*(n_{f}−nₛ)*P_{DC}/λ. The degree of dispersion change increases as the magnitude of β increases. Accordingly, the magnitude of β can be increased when a broader dispersion profile is desired.

Other values of α and β can be used to change other features of the dispersion profile. For instance, when α is greater than 2, β is positive and (n_{f}−nₛ)>0 or when α is greater than 2, β is negative and (n_{f}−nₛ)<0, positive dispersion slope results as shown in FIG. 3E and FIG. 3F. FIG. 3E shows the dispersion profile of the light signal as the light signal before entering the functional region 25 and FIG. 3F shows the dispersion profile of the light signal after the light signal exits the functional region 25. The functional region 25 causes the output dispersion profile to shift toward longer times as compared to the input light signal. This shift is caused by the dispersion slope. The degree of dispersion slope change increases as the magnitude of β increases. Accordingly, the magnitude of β can be increased when a more positive dispersion slope is desired. As illustrated, positive dispersion slope can be used to provide a more symmetrical signal in the output.

When α is greater than 2, β is negative and (n_{f}−nₛ)>0 or when α is greater than 2, β is positive and (n_{f}−nₛ)<0, negative dispersion slope results as shown in FIG. 3G and FIG. 3H. FIG. 3G shows the dispersion profile of the light signal as the light signal before entering the functional region 25 and FIG. 3H shows the dispersion profile of the light signal after the light signal exits the functional region 25. The functional region 25 causes the output dispersion profile to shift more toward shorter times than the input light signal. The degree of dispersion slope change increases as the magnitude of β increases. Accordingly, the magnitude of β can be increased when a more negative dispersion slope is desired. As illustrated, negative dispersion slope can be used to provide a more symmetrical signal in the output.

When α is increased to three or higher the optical component 10 can compensate for higher order dispersion. Hence, the optical component 10 has the ability to compensate an arbitrary dispersion response using higher order dispersion changing functions.

A suitable C for use in equation 2 includes, but is not limited to, a function of N. A suitable function of N includes, but is not limited to, −(N+1)/2 as shown in Equation 3 and −N/2. When C is −(N+1)/2, the exponential function is centered relative to the array waveguides 26. More specifically, the path having the smallest pathlength, Pj, is the path associated with the (N+1)/2th array waveguide 26 when the number of array waveguides 26 is odd and the path associated with the N/2−0.5th and N/2+0.5th array waveguides 26 when the number of array waveguides 26 is even. The exponential function need not be centered relative to the array waveguides 26 in order for the optical component 10 to operate. For instance, C can be equal to zero.

P(j)=P_{DC}(j)=β(j−(N+1)/2)^{α} (3)

The effects of the variable component, P(j), are additive. As a result, the length of the array waveguides 26 can include more than one variable component, P(j). For instance, the array waveguide grating 24 can be designed so as to produce negative dispersion and positive dispersion slope. As a result, the dispersion profile on the output waveguide 16 would be narrower and more shifted toward the longer times than the dispersion profile on the input waveguide 12. Other combinations include, but are not limited to, negative dispersion and negative dispersion slope; positive dispersion and positive dispersion slope or positive dispersion and negative dispersion slope.

Equation 4 shows an equation for the length of array waveguides 26 having more than one variable component, P(j).

Pⱼ=Po+P_{DC}(j)+P′_{DC}(j)=Po+β(j−N/2)^{α}+β′(j−N/2)^{α′} (4)

The value of α, α′, β and β′ are selected so as to achieve the desired combination of variable component effects. For instance, when it is desired to produce an optical component 10 having negative dispersion and positive dispersion slope, the value of α is 2, βis negative and (n_{f}−nₛ)>0 in order to provide the negative dispersion and α′ is greater than 2 and β′ is positive and (n_{f}−nₛ)>0 in order to provide the positive dispersion slope. The values of 62 and β′ are often less than one.

The functional region 25 can be designed to have pathlengths that provide the optical component 10 with a demultiplexing function. The demultiplexing function causes light signals having different wavelengths to be directed to different regions of the output side 22 of the output light distribution component 18. Designing the functional region 25 such that each pathlength is different and such the difference in the adjacent pathlengths is a constant can provide the demultiplexing function. For instance, the variable component, P(j), can include a demultiplexing function, P_{D}(j), such as P_{D}(j)=(j−1)ΔP, (j)ΔP, (N−j) ΔP or (N−j+1) ΔP where ΔP is a non-zero constant and P₀ can be equal to 0, ΔP or another constant.

In order to simplify describing operation of an optical component 10 having a demultiplexing function, P_{D}(j), it is presumed that the variable component, P(j) is equal to the demultiplexing function, P_{D}(j) and that the length of each array waveguide 26 is the same. During operation of the optical component 10 so as to provide a demultiplexing function, P_{D}(j), each array waveguide 26 carries the received light signal portion to the output light distribution component 18. The portion of a light signal traveling through the functional region 25 along a long pathlength will take longer to cross the functional region 25 than the portion of a light signal traveling through the functional region 25 along a shorter pathlength. As a result, these portions of the light signal enter the array waveguides 26 and accordingly the output light distribution component 18 in different phases.

The light signal portion entering the output light distribution component 18 from each of the array waveguides 26 combines to form the output light signal. Because the functional region 25 causes a phase differential between the portions of the light signal entering the output light distribution component 18 from different paths, the output light signal is diffracted at an angle. The output light distribution component 18 is constructed to converge the output light signal at a location on the output side 22 of the output light distribution component 18. The location where the output light signal is incident on the output side 22 of the output light distribution component 18 is a function of the diffraction angle.

Because ΔP is a different percent of the wavelength for each channel, the amount of the phase differential is different for different channels. As a result, different channels are diffracted at different angles and are accordingly converged at different locations on the output side 22. Hence, when a multichannel beam enters the output light distribution component 18, each of the different channels is converged at a different location on the output side 22. The output waveguides 16 are positioned at each location on the output side 22 where a channel is converged. As a result, each output waveguide 16 carries a different channel.

The functional region 25 can be configured to provide only a demultiplexing function or only a dispersion changing function. Additionally, the functional region 25 can be configured to provide a demultiplexing function and a dispersion changing function. For instance, the demultiplexing function, P_{D}(j), is additive with the one or more dispersion changing functions, P_{DC}(j). As a result, the variable component, P(j), can include both a dispersion changing function, P_{DC}(j), and a demultiplexing function, P_{D}(j). When the functional region 25 is configured to have both a demultiplexing function, P_{D}(j), and a dispersion changing function, P_{DC}(j), the output light signal associated with each channel exhibits the effects of the dispersion changing function, P_{DC}(j). For instance, when the dispersion changing function, P_{DC}(j), provides a narrowing of the dispersion profile, each of the output light signals on an output waveguide 16 has a narrower dispersion profile than the associated input light signal had on the input waveguide 12. Accordingly, the optical component 10 can concurrently provide dispersion changing functions, P_{DC}(j), and a demultiplexing function, P_{D}(j).

The dispersion changing function, PDC(j), does have some affect on the bandwidth of the demultiplexing function. The amount of the bandwidth change is reduced with reduced values of β and α. Further, the amount of bandwidth change is generally low when β and α are less than one. However, the amount of change to the bandwidth can often be designed out or is often negligible.

Equation 5 shows an equation for the pathlengths, Pⱼ, of a functional region 25 having both a demultiplexing function, P_{D}(j), and a dispersion changing function, P_{DC}(j). The value of ΔP, α and β are selected so as to achieve the desired combination of demultiplexing and dispersion. For instance, when it is desired to produce demultiplexing and negative dispersion, ΔP is not equal to zero, the value of α is 2 and β is negative.

Pⱼ=Po+P_{D}(j)+P_{DC}(j)=Po+jΔP+β(j+C)^{α} (5)

As noted above, the dispersion changing functions, P_{DC}(j), are additive. As a result, Equation 5 can include two or more dispersion changing functions, P_{DC}(j), as shown in Equation 6.

Pⱼ=Po+P_{D}(j)+P_{DC}(j)+P′_{DC}(j) (6)

In some instances, the side of the functional region through which the light signals enter the functional region has a shape that matches the shape of the light signal wavefront. Accordingly, the side of the functional region through which the light signals enter can have a shape that is substantially semi-circular while preserving the pathlength, Pⱼ, relationships discussed above. Matching the side of the functional region to the wavefront causes the light signal to enter the functional region at an angle that is substantially perpendicular. The perpendicular angle reduces bending or reflection of the light signal in response to the change in the index of refraction that occurs at the functional region.

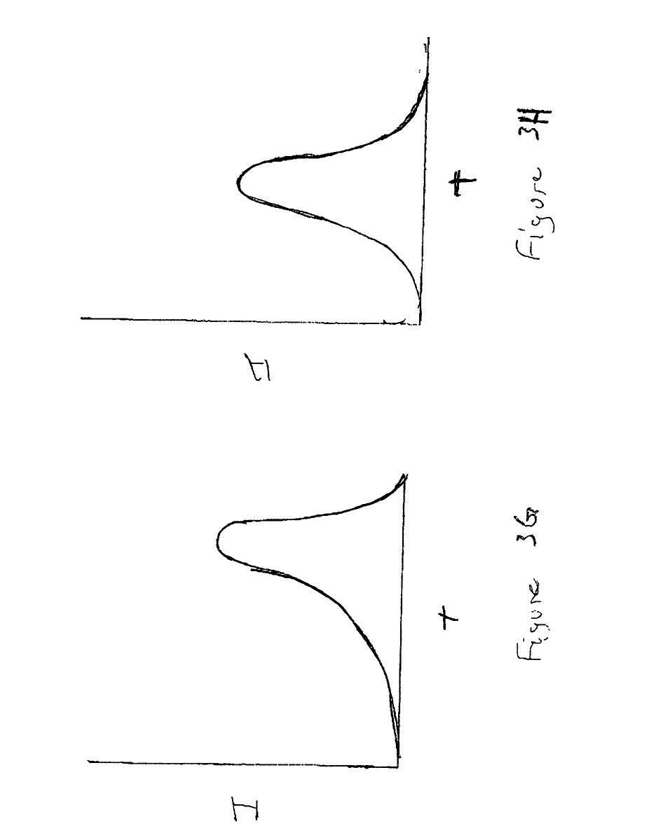

Each of the optical components 10 shown above can be constructed with a single light distribution component 11 by positioning reflectors 50 along the array waveguides 26 as shown in FIG. 4A. The optical component 10 includes an input waveguide 12 and an output waveguide 16 that are each connected to the output side 22 of the light distribution component 11. The array waveguides 26 include a reflector 50 configured to reflect light signal portions back toward the light distribution component 11.

The optical component 10 of FIG. 4A has array waveguides 26 with lengths selected as described above. However, the light signal travels through the functional region 25 twice. As a result, the effective pathlength of each array waveguide 26 is about twice the actual length. Accordingly, the pathlengths of the functional region 25 illustrated in FIG. 4A can be half the pathlengths of the functional region 25 shown in FIG. 1A while still providing the same degree of functionality.

FIG. 4B illustrates another embodiment of an optical component 10 having a single light distribution component 11 and curved array waveguides 26. The optical component 10 is included on an optical component 10. The edge of the optical component 10 is shown as a dashed line. The edge of the optical component 10 can include one or more reflective coatings positioned so as to serve as reflector(s) 50 that reflect light signals from the array waveguides 26 back into the array waveguides 26. Alternatively, the edge of the optical component 10 can be smooth enough to act as a mirror that reflects light signals from the array waveguide 26 back into the array waveguide 26. An optical component 10 having an optical component 10 according to FIG. 4B can be fabricated by making an optical component 10 having an optical component 10 according to FIG. 1A, FIG. 1B or FIG. 1C and cleaving the optical component 10 down the center of the array waveguides 26. When the optical component 10 was symmetrical about the cleavage line, two optical components 10 can result. Because, the light signal must travel through each array waveguide 26 twice, each resulting optical components 10 will provide about the same degree of dispersion compensation as would have been achieved before the optical component 10 was cleaved.

Although the optical component 10 of FIG. 4A and FIG. 4B are shown with a single input waveguide 12 and a single output waveguide 16, the optical component 10 can include a plurality of input waveguides 12 and/or a plurality of output waveguides 16. Accordingly, the optical components 10 of FIG. 4A and FIG. 4B can also be adapted to provide demultiplexing functions in addition to dispersion compensation.

The optical components 10 illustrated above can include more than one functional region 25. For instance, a first functional region 25 can be positioned in an input light distribution component 14 and a second functional region 25 can be positioned in an output light distribution component 18. Further, more than one functional region 25 can be positioned in a light distribution component 11. When the optical component 10 includes more than one functional region 25, the functionality provided by the functional regions 25 can enhance one another. For instance, a first functional region 25 and a second functional region 25 can both be configured to provide a demultiplexing function. Further, the functionality provided by a first functional region 25 can be different from the functionality provided by a second functional region 25. For instance, a first functional region 25 positioned in the input light distribution component can be configured to provide positive dispersion and a second functional region 25 positioned in the output light distribution component can be configured to provide positive slope dispersion.

The array waveguide grating 24 can be configured to provide the optical component 10 with one or more dispersion compensation functions and/or a demultiplexing function as described in U.S. patent application Ser. No. 09/866491; filed on May 25, 2001; entitled “Dispersion Compensator” and incorporated herein in its entirety. The functionality provided by the array waveguide grating 24 can enhance the functionality provided by the one or more functional regions 25. For instance, the functional region 25 and the array waveguide grating 24 can both be configured to provide a demultiplexing function. Further, the functionality provided by the array waveguide grating 24 can be different from the functionality provided by the one or more functional regions 25. For instance, the functional region 25 can be configured to provide positive dispersion and the array waveguide grating 24 can be configured to provide positive slope dispersion.

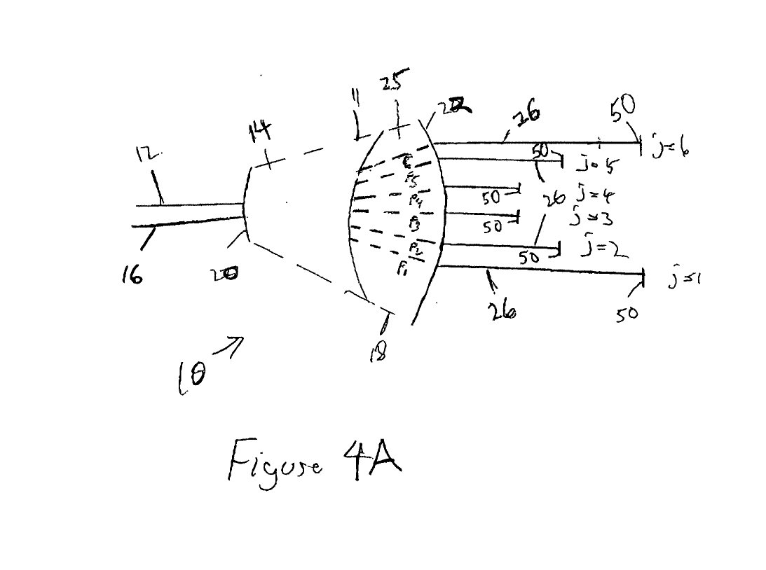

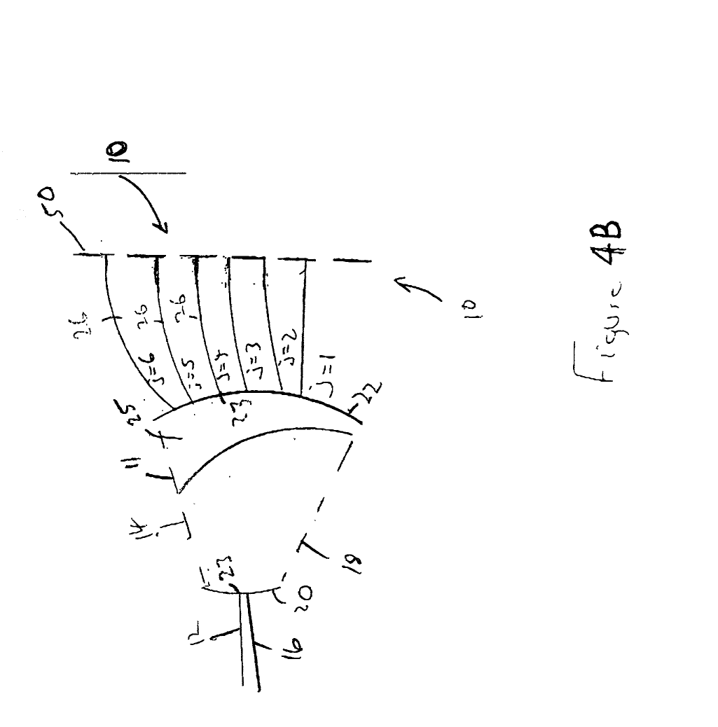

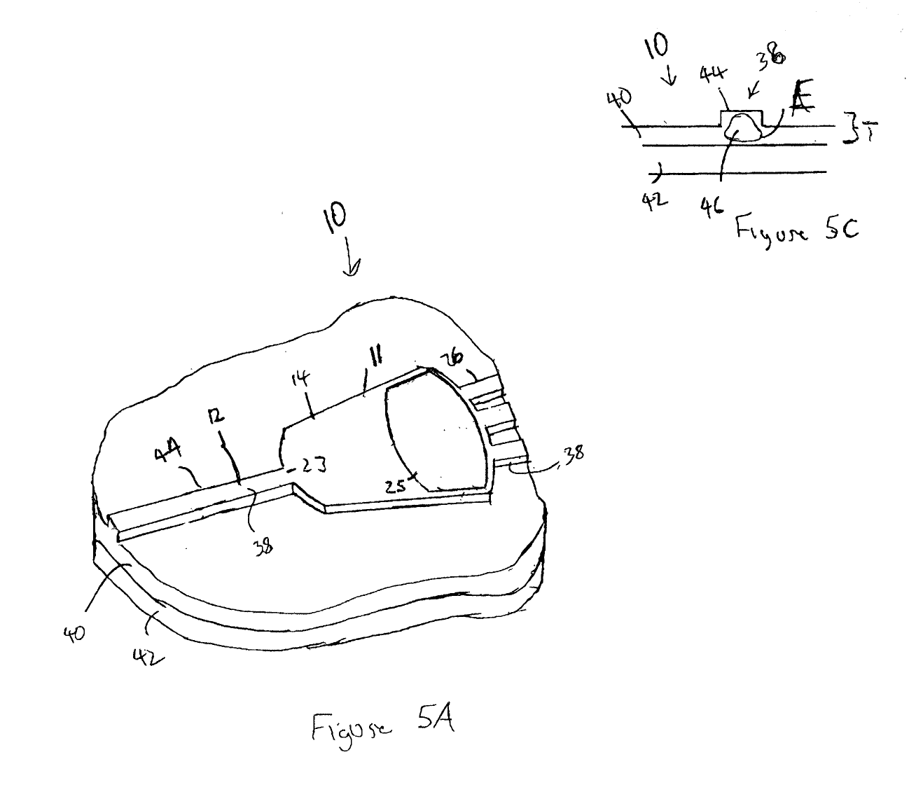

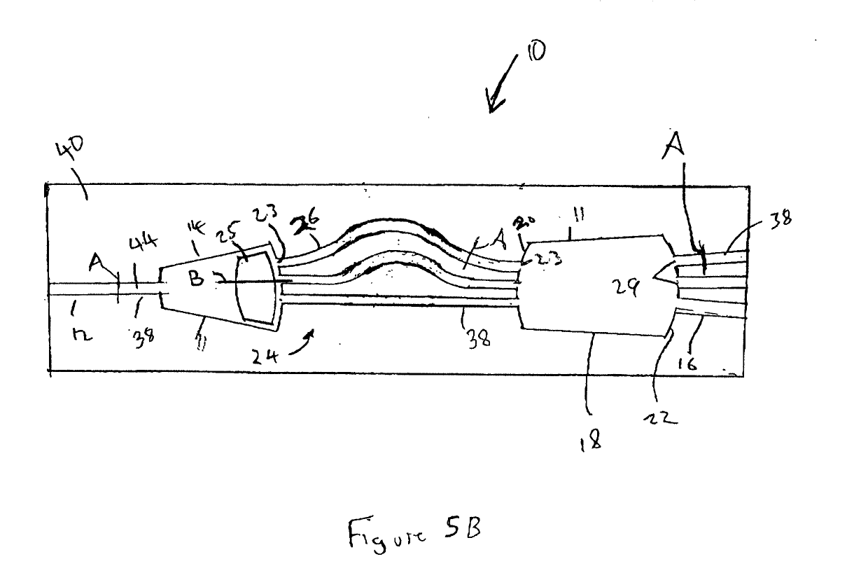

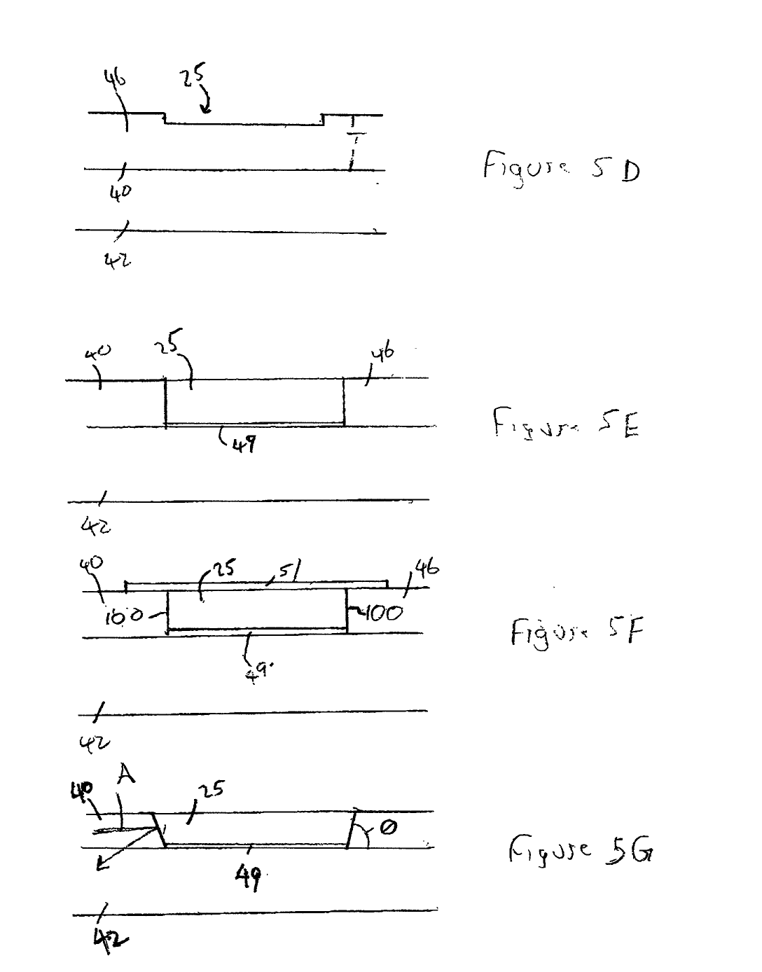

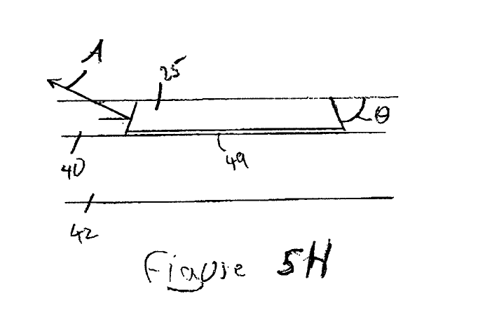

FIG. 5A through FIG. 5G illustrate suitable construction of an optical component 10 having a functional region 25. FIG. 5A is a perspective view of a portion of an optical component 10. The illustrated portion has an input light distribution component 14, an input waveguide 12 and a plurality of array waveguides 26. FIG. 5B is a topview of an optical component 10 constructed according to FIG. 5A. FIG. 5C is a cross section of the optical component 10 in FIG. 5B taken at any of the lines labeled A. Accordingly, the waveguide 38 illustrated in FIG. 5C could be the cross section of an input waveguide 12, an array waveguide 26 or an output waveguide 16.

For purposes of illustration, the optical component 10 is illustrated as having three array waveguides 26 and an output waveguide 16. However, array waveguide 26 gratings 24 for use with an optical component 10 can have many more than three array waveguides 26. For instance, array waveguide 26 gratings 24 can have tens to hundreds or more array waveguides 26.

The optical component 10 includes a light transmitting medium 40 on a base 42. The light transmitting medium 40 includes a ridge 44 that defines a portion of the light signal carrying region 46 of a waveguide 38. The light signal carrying region 46 is associated with a thickness, T. Suitable light transmitting media include, but are not limited to, silicon, polymers, silica, GaAs, InP, SiN, SiC and LiNbO₃. As will be described in more detail below, the base 42 reflects light signals from the light signal carrying region 46 back into the light signal carrying region 46. As a result, the base 42 also defines a portion of the light signal carrying region 46. The line labeled E illustrates the mode profile of a light signal carried in the light signal carrying region 46 of FIG. 5C. The light signal carrying region 46 extends longitudinally through the input waveguide 12, the input light distribution component 14, each the array waveguides 26, the output light distribution component 18 and each of the output waveguides 16.

A variety of functional region 25 constructions are possible as illustrated in FIG. 5D through FIG. 5G. FIG. 5D through FIG. 5F are each cross sections of the optical component 10 taken along the line labeled B in FIG. 5B.

The functional region 25 can be a region of the light transmitting medium 40 where the thickness of the light signal carrying region 46 changes as shown in FIG. 5D. Although the thickness of the light signal carrying region 46 is shown as being reduced in the functional region 25, the thickness of the light signal carrying region 46 can increase in the functional region 25. Decreasing the thickness, T, of the light signal carrying region in the functional region decreases the index of refraction in the functional region 25 while increasing the thickness, T, in the light signal carrying region 46 thickness increases the index of refraction in the functional region 25.

The light transmitting medium 40 can change in the functional region 25 as illustrated in FIG. 5E. The light transmitting medium 40 in the functional region 25 can have a different index of refraction than the light transmitting medium 40 outside of the functional region 25. A layer of material 49 can optionally be positioned between the base and the light transmitting medium 40 of the functional region 25. The layer of material 49 can be selected so as to prevent the light signal from entering the base 42. For instance, the layer of material 49 can have reflective properties such as a metal or can have a lower index of refraction than the top layer of the base 42. When the layer of material 49 has reflective properties or an index of refraction lower than the light transmitting medium 40 in the functional region 25, the layer of material 49 reflects the light signal into the light transmitting medium 40 and away from the base 42. An example of an optical component 10 having a layer of material 49 includes an optical component 10 having silicon as the light transmitting medium 40 outside of the functional region 25, silica doped with P₂O₅, TiO₂, or GeO₂ as the light transmitting medium 40 in the functional region 25, and undoped silica as the layer of material 49.

In some instances, the light transmitting medium 40 in the functional region 25 is a gas as shown in FIG. 5F. A layer of material 49 can optionally be positioned between the base 42 and the light transmitting medium 40 of the functional region 25. The layer of material 49 can be selected so as to prevent the light signal from entering the base 42. A reflective layer 51 can also be positioned over the functional region 25. The reflective layer 51 prevents the light signal from exiting the function region. For instance, the reflective layer 51 can be a layer of metal that reflects a light signal from the functional region 25 back into the functional region 25.

The sides of the functional region 25 can optionally include an anti-reflective coating 100 as illustrated in FIG. 5F. The anti-reflective coating reduces the amount of reflection that occurs at the interface of the different light transmitting media.

The sides of the functional region 25 can optionally be angled at less than ninety degrees as shown by the angle labeled θ in FIG. 5G or FIG. 5H. An angle less than ninety degrees can cause a light signal that is reflected at the interface of the different light transmitting media to be reflected out of the light signal carrying region 46 as shown by the arrow labeled A. As a result, an angle less than ninety degrees can reduce resonance of the light signals in the optical component 10. A suitable angle, θ, includes, but is not limited to, an angle less than 89°, less than 87°, less than 85°, 70° to 87°, 77° to 85° or 82° to 85°. The angled facet can cause the length of a path to change depending on height above the base 42 where the pathlength is measured. As a result, the pathlength can refer to the pathlength averaged over the height or measured at a particular point along the height or some other measure of length.

A cladding layer 48 can be optionally being positioned over the light transmitting medium 40 as shown in FIG. 5I. The cladding layer 48 can have an index of refraction less than the index of refraction of the light transmitting medium 40 so light signals from the light transmitting medium 40 are reflected back into the light transmitting medium 40. Because the cladding layer 48 is optional, the cladding layer 48 is shown in some of the following illustrations and not shown in others.

FIG. 5J illustrates a suitable construction of a reflector 50 for use within optical component 10 such as the optical component 10 of FIG. 4A. The reflector 50 includes a reflecting surface 52 positioned at an end of an array waveguide 26. The reflecting surface 52 is configured to reflect light signals from an array waveguide 26 back into the array waveguide 26. The reflecting surface 52 extends below the base of the ridge 44. For instance, the reflecting surface 52 can extend through the light transmitting medium 40 to the base 42 and in some instances can extend into the base 42. The reflecting surface 52 extends to the base 42 because the light signal carrying region 46 is positioned in the ridge 44 as well as below the ridge 44 as shown in FIG. 5C. As result, extending the reflecting surface 52 below the base of the ridge 44 increases the portion of the light signal that is reflected.

The array waveguides 26 of FIG. 5B are shown as having a curved shape. A suitable curved waveguide 38 is taught in U.S. patent application Ser. No. 09/756498, filed on Jan. 8, 2001, entitled “An efficient Curved Waveguide” and incorporated herein in its entirety. Other optical component 10 constructions can also be employed. For instance, the principles of the invention can be applied to array waveguide 26 gratings 24 having straight array waveguides 26. Array waveguide 26 gratings 24 having straight array waveguides 26 are taught in U.S. patent application Ser. No. 09/724175, filed on Nov. 28, 2000, entitled “A Compact Integrated Optics Based Array Waveguide Demultiplexer” and incorporated herein in its entirety.

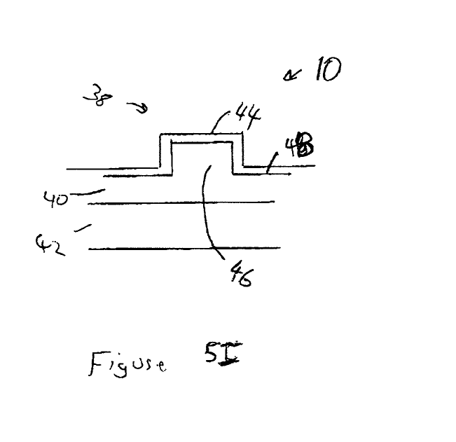

The base 42 can have a variety of constructions. FIG. 6A illustrates a optical component 10 having a base 42 with a light barrier 80 positioned over a substrate 82. The light barrier 80 serves to reflect the light signals from the light signal carrying region 46 back into the light signal carrying region 46. Suitable light barriers 80 include material having reflective properties such as metals. Alternatively, the light barrier 80 can be a material with a different index of refraction than the light transmitting medium 40. The change in the index of refraction can cause the reflection of light from the light signal carrying region 46 back into the light signal carrying region 46. A suitable light barrier 80 would be silica when the light carrying medium and the substrate 82 are silicon. Another suitable light barrier 80 would be air or another gas when the light carrying medium is silica and the substrate 82 is silicon. A suitable substrate 82 includes, but is not limited to, a silicon substrate 82.

The light barrier 80 need not extend over the entire substrate 82 as shown in FIG. 6B. For instance, the light barrier 80 can be an air filled pocket formed in the substrate 82. The pocket 84 can extend alongside the light signal carrying region 46 so as to define a portion of the light signal carrying region 46.

In some instances, the light signal carrying region 46 is adjacent to a surface 86 of the light barrier 80 and the light transmitting medium 40 is positioned adjacent to at least one side 88 of the light barrier 80. As a result, light signals that exit the light signal carrying region 46 can be drained from the waveguide 38 as shown by the arrow labeled A. These light signals are less likely to enter adjacent array waveguide 26. Accordingly, these light signals are not a significant source of cross talk.

The drain effect can also be achieved by placing a second light transmitting medium 90 adjacent to the sides 88 of the light barrier 80 as indicated by the region below the level of the top dashed line or by the region located between the dashed lines. The drain effect is best achieved when the second light transmitting medium 90 has an index of refraction that is greater than or substantially equal to the index of refraction of the light transmitting medium 40 positioned over the base 42. In some instances, the bottom of the substrate 82 can include an anti reflective coating that allows the light signals that are drained from a waveguide 38 to exit the optical component 10.

The input waveguide 12, the array waveguides 26 and/or the output waveguide 16 can be formed over a light barrier 80 having sides 88 adjacent to a second light transmitting medium 90.

The drain effect can play an important role in improving the performance of the optical component 10 because the array waveguide grating 24 includes a large number of waveguides 38 formed in close proximity to one another. The proximity of the waveguides 38 tends to increase the portion of light signals that act as a source of cross talk by exiting one waveguide 38 and entering another. The drain effect can reduce this source of cross talk.

Other base 42 and optical component 10 constructions suitable for use with an optical component 10 according to the present invention are discussed in U.S. patent application Ser. No. 09/686,733, filed on Oct. 10, 2000, entitled “Waveguide Having a Light Drain” and U.S. patent application Ser. No. 09/784,814, filed on Feb. 15, 2001, entitled “Component Having Reduced Cross Talk” each of which is incorporated herein in its entirety.

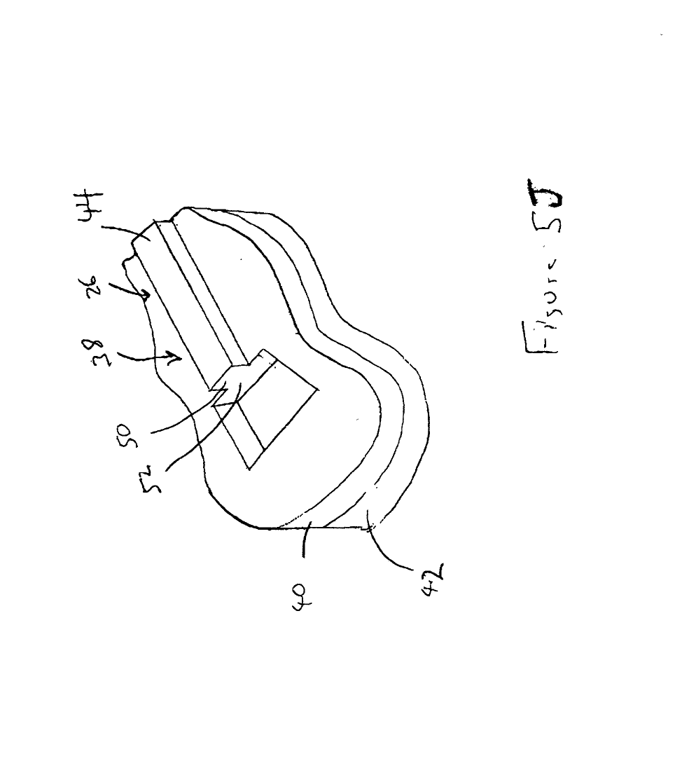

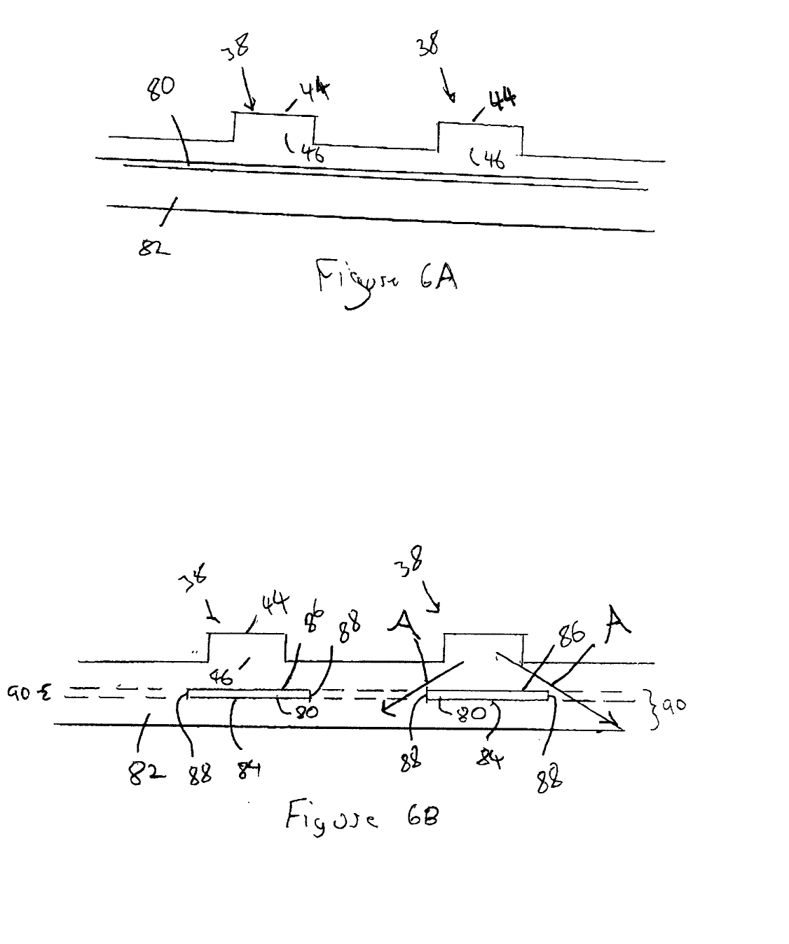

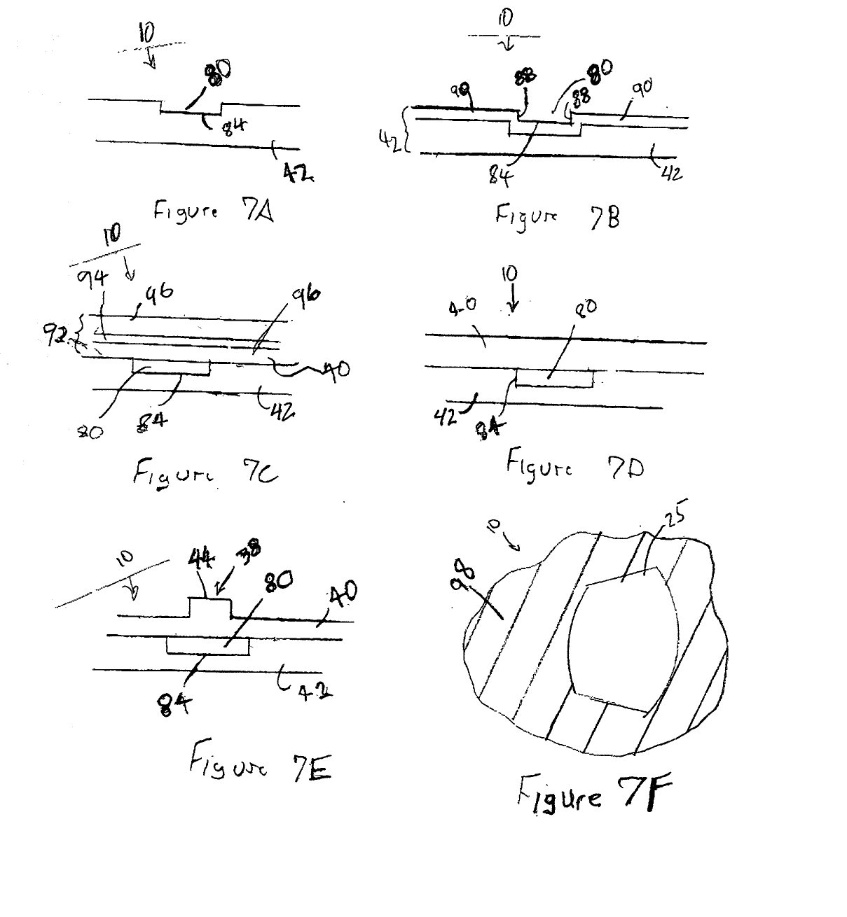

FIG. 7A to FIG. 7F illustrate a method for forming a optical component 10 having an optical component 10. A mask is formed on a base 42 so the portions of the base 42 where a light barrier 80 is to be formed remain exposed. A suitable base 42 includes, but is not limited to, a silicon substrate. An etch is performed on the masked base 42 to form pockets 84 in the base 42. The pockets 84 are generally formed to the desired thickness of the light barrier 80.

Air can be left in the pockets 84 to serve as the light barrier 80. Alternatively, a light barrier 80 material such as silica or a low K material can be grown or deposited in the pockets 84. The mask is then removed to provide the optical component 10 illustrated in FIG. 7A.

When air is left in the pocket 84, a second light transmitting medium 90 can optionally be deposited or grown over the base 42 as illustrated in FIG. 7B. When air will remain in the pocket 84 to serve as the light barrier 80, the second light transmitting medium 90 is deposited so the second light transmitting medium 90 is positioned adjacent to the sides 88 of the light barrier 80. Alternatively, a light barrier 80 material such as silica can optionally be deposited in the pocket 84 after the second light transmitting medium 90 is deposited or grown.

The remainder of the method is disclosed presuming that the second light transmitting medium 90 is not deposited or grown in the pocket 84 and that air will remain in the pocket 84 to serve as the light barrier 80. A light transmitting medium 40 is formed over the base 42. A suitable technique for forming the light transmitting medium 40 over the base 42 includes, but is not limited to, employing wafer bonding techniques to bond the light transmitting medium 40 to the base 42. A suitable wafer for bonding to the base 42 includes, but is not limited to, a silicon wafer or a silicon on insulator wafer 92.

A silicon on insulator wafer 92 includes a silica layer 94 positioned between silicon layers 96 as shown in FIG. 7C. The top silicon layer 96 and the silica layer 94 can be removed to provide the optical component 10 shown in FIG. 7D. Suitable methods for removing the top silicon layer 96 and the silica layer 94 include, but are not limited to, etching and polishing. The bottom silicon layer 96 remains as the light transmitting medium 40 where the waveguides 38 will be formed. When a silicon wafer is bonded to the base 42, the silicon wafer will serve as the light transmitting medium 40. A portion of the silicon layer 96 can be removed from the top and moving toward the base 42 in order to obtain a light transmitting medium 40 with the desired thickness.

A silicon on insulator wafer can be substituted for the component illustrated in FIG. 7D. The silicon on insulator wafer preferably has a top silicon layer with a thickness that matches the desired thickness of the light transmitting medium 40. The remainder of the method is performed using the silicon on insulator wafer in order to create an optical component 10 having the base 42 shown in FIG. 6A.

The light transmitting medium 40 is masked such that places where a ridge 44 is to be formed are protected. The optical component 10 is then etched to a depth that provides the optical component 10 with ridges 44 of the desired height as shown in FIG. 7E.

The functional region 25 can be formed by performing a mask and etch on the optical component 10 of FIG. 7E. For instance, FIG. 7F is a topview of the optical component 10 of FIG. 7E with a mask 98 formed over the light transmitting medium 40. The location where the functional region 25 is to be formed remains exposed. The light transmitting medium in the functional region can be replaced with a second light transmitting medium having a different index of refraction than the light transmitting medium using techniques such as doping, ion exchange and diffusion techniques on the exposed region of the light transmitting medium. Alternatively, the mask 98 can be formed so the location where the functional region will be formed is protected. Doping, ion exchange or diffusion techniques can be employed on the exposed region of the light transmitting medium to replace the light transmitting medium outside of the functional region with a second light transmitting medium.

As noted above, the light signal carrying region in the functional region can have a different thickness than the light signal carrying region outside of the functional region. The different thickness can be formed by forming a mask 98 over the light transmitting medium 40 as shown in FIG. 7F. The exposed light transmitting medium 40 can be etched so as to reduce the thickness of the light signal carrying region in the functional region to a desired thickness, T. As noted above, the reduced thickness, T, in the light signal carrying region reduces index of refraction in the functional region 25. The mask 98 can then be removed to provide the functional region 25 shown in FIG. 5D.

The functional region 25 can be formed such that the light signal carrying region 46 is thicker inside the functional region 25 than outside of the functional region 25. For instance, the mask can be formed such that the location where the functional region 25 is to be formed is protected and the exposed light transmitting medium 40 etched. The etch reduces the thickness of the light signal carrying region 46 outside of the functional region 25 while the thickness of the light signal carrying region 46 in the functional region 25 remains unchanged. The mask is then removed to provide a light distribution component 11 having a light signal carrying region 46 that is thicker inside the functional region 25 than outside of the functional region 25.

The functional region 25 defined in FIG. 7F can also be formed by replacing a portion of the light transmitting medium 40 with another light transmitting medium 40. For instance, when a silicon on insulator wafer is substituted for the component illustrated in FIG. 7D, a mask can be formed on the light transmitting medium 40 such that the region where the functional region 25 is to be formed. An etch is performed so as to remove the light transmitting medium 40 from the region where the functional region 25 will be formed. In some instances, an anti-reflective coating is formed on the sides of the functional region 25 before the second light transmitting medium 40 is formed or deposited. When a layer of material 49 is to be formed between the base and the light transmitting medium 40 of the functional region 25, the layer of material 49 can be grown or deposited in the functional region 25. For instance, undoped silica can be grown or deposited in the functional region 25 as the layer of material 49. A second light transmitting medium 40 such as silica doped with TiO₂, GeO₂, or P₂O₅ can then be grown or deposited over the layer of material 49 in the functional region 25 to provide the functional region 25 shown in FIG. 7F.

As an alternative to forming the second light transmitting medium 40, air can serve as the light transmitting medium 40 in the functional region 25. As a result, the reflective layer 51 can be formed over the functional region 25 after forming the layer of material 49 or after removing the light transmitting medium 40.

When the optical component 10 will include a cladding 48, the cladding 48 can be formed at different places in the method. For instance, the cladding 48 can be deposited or grown on the optical component 10 of FIG. 7E.

The etch(es) employed in the method described above can result in formation of a facet and/or in formation of the sides of a ridge 44 of a waveguide. These surfaces are preferably smooth in order to reduce optical losses. Suitable etches for forming these surfaces include, but are not limited to, reactive ion etches, the Bosch process and the methods taught in U.S. patent application Ser. No. 09/690,959; filed on Oct. 16, 2000; and entitled “Formation of a Smooth Vertical Surface on an Optical Component” which is incorporated herein in its entirety.

As noted above, the optical component 10 can be constructed such that the array waveguides 26 include a reflector 50. A suitable method for forming a reflector 50 is taught in U.S. patent application serial number 09/723,757, filed on Nov. 28, 2000, entitled “Formation of a Reflecting Surface on an Optical Component” and incorporated herein in its entirety.

Although the optical component is disclosed in the context of optical components having ridge waveguides, the principles of the present invention can be applied to optical components having other waveguide types. Suitable waveguide types include, but are not limited to, buried channel waveguides and strip waveguide.

Light distribution components constructed as discussed above can also be employed with other optical components. For instances, the above light distribution components can be employed with diffraction gratings. As an example, the light distribution components illustrated in FIG. 4A and FIG. 4B can include reflective a diffraction grating positioned on the output side of the light distribution component in place of the array waveguide grating.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical component, comprising:
a light distribution component having a light signal carrying region for carrying a light signal through the light distribution component; and
a functional region positioned in the light distribution component such that the light signal carrying region extends through at least a portion of the functional region, the index of refraction of the light signal carrying region inside of the functional region being different from the index of refraction of the light signal carrying region outside of the functional region, the functional region shaped such that the dispersion profile of the light signal changes in response to traveling through the functional region.

2. The component of claim 1, further comprising:
an array waveguide grating having a plurality of array waveguides in optical communication with the light distribution component such that the light signal carrying region extends through the array waveguides, each array waveguide being configured to carry a portion of the light signal.

3. The component of claim 2, wherein at least a portion of the array waveguides are associated with a path through the functional region, the portion of the light signal traveling through an array waveguide also traveling along the associated path through the functional region, each path through the functional region being associated with a path index j, the length of the paths including one or more exponential functions having a base that is a function of the array waveguide index j.

4. The component of claim 3, wherein the exponential function includes β(j+C)^{α}, C, α and β each having a constant value for each array waveguide.

5. The component of claim 3, wherein α is about 2.

6. The component of claim 3, wherein β is positive.

7. The component of claim 3, wherein β is negative.

8. The component of claim 3, wherein α is greater than 2.

9. The component of claim 3, wherein the length of the array waveguides includes more than one exponential function of the array waveguide index.

10. The component of claim 2, wherein at least a portion of the array waveguides are associated with a path through the functional region, the portion of the light signal traveling through an array waveguide also traveling along the associated path through the functional region, each path through the functional region being associated with a path index j, the length of the paths including a linear function of the array waveguide index j.

11. The component of claim 10, wherein the linear function includes jΔP where ΔP is a constant for each path.

12. The component of claim 1, further comprising:
an array waveguide grating having a plurality of array waveguides in optical communication with the light distribution component such that the light signal carrying region extends through the array waveguides, the light distribution component being an input light distribution component configured to distribute the light signal across the array waveguides of the array waveguide grating.

13. The component of claim 12, further comprising:
an output light distribution component configured to receive the portions of the light signal from the array waveguide and to combine the portions of the light signal into an output light signal directed toward an output side of the second light distribution component.

14. The component of claim 1, further comprising:
an array waveguide grating having a plurality of array waveguides in optical communication with the light distribution component such that the light signal carrying region extends through the array waveguides, the light distribution component being an output light distribution component positioned to receive a portion of the light signal from each array waveguide and to combine the portions of the light signal into an output light signal directed toward an output side of the light distribution component.

15. The component of claim 14, further comprising:
an input light distribution component configured to distribute the light signal to the array waveguides such that each array waveguide receives a portion of the light signal.

16. The component of claim 1, wherein the light distribution component has a geometry selected from a group consisting of a star coupler and a Rowland circle.

17. The component of claim 1, wherein the functional region is configured so as to narrow the dispersion profile of the light signal.

18. The component of claim 1, wherein the functional region configured so as to broaden the dispersion profile of the light signal.

19. The component of claim 1, wherein the functional region is configured so as to increase the dispersion slope of the light signal.

20. The component of claim 1, wherein the functional region is configured so as to decrease the dispersion slope of the light signal.

21. A method of operating an optical component, comprising:
receiving a light signal in a light distribution component having a light signal carrying region with an index of refraction; and
directing the light signal through a functional region positioned in the light distribution component such that the light signal carrying region extends through the functional region, the index of refraction of the light signal carrying region inside of the functional region being different from the index of refraction of the light signal carrying region inside of the functional region and the functional region being shaped such that the dispersion profile of the light signal changes in response to traveling through the functional region.

22. A method of fabricating an optical component, comprising:
forming a light distribution component in a light transmitting medium positioned on a base, the light distribution component being formed so as to have a light signal carrying region defined in the light transmitting medium, the light signal carrying region having a thickness; and
removing a portion of the light transmitting medium so as to define a functional region in the light distribution component, the light transmitting medium being removed such that the thickness of the light signal carrying region is different inside of the functional region and outside of the functional region.

23. The method of claim 22, wherein the light signal carrying region is thicker inside of the functional region than outside of the functional region.

24. The method of claim 22, wherein the light signal carrying region is thinner inside of the functional region than outside of the functional region.

25. The method of claim 22, wherein the functional region is the functional region is shaped such that the dispersion profile of the light signal changes in response to traveling through the functional region.

26. A method of fabricating an optical component, comprising:
defining a light distribution component in a light transmitting medium positioned on a base, the light distribution component being defined so as to have a light signal carrying region defined in the light transmitting medium; and
removing at least a portion of the light transmitting medium so as to define a functional region in the light signal carrying region of the light distribution component, the functional region shaped such that the dispersion profile of the light signal changes in response to traveling through the functional region.

27. The method of claim 26, wherein the signal carrying region has a thickness and the light transmitting medium is removed such that a thickness of the light signal carrying region in the functional region is different from the thickness of the light signal carrying region outside of the functional region.

28. The method of claim 26, further comprising:
forming a reflective layer over the functional region with air remaining in the functional region.

29. The method of claim 26, further comprising:
forming a second light transmitting medium in the functional region.
